(19) United States
(12) Patent Application Publication
(10) Pub. No.: US 2024/0053455 A1
(43) Pub. Date: Feb. 15, 2024

(54) SAFETY DEVICE FOR AT LEAST ONE LIGHT SOURCE, EMITTING DEVICE FOR LIGHT, DETECTION APPARATUS, VEHICLE HAVING AT LEAST ONE DETECTION APPARATUS, AND METHOD FOR OPERATING AT LEAST ONE LIGHT SOURCE

(71) Applicant: Valeo Schalter und Sensoren GmbH, Bietigheim-Bissingen (DE)

(72) Inventors: Johannes Appl, Bietigheim-Bissingen (DE); Juergen Nies, Bietigheim-Bissingen (DE); Thomas Schuler, Bietigheim-Bissingen (DE); Christoph Parl, Bietigheim-Bissingen (DE)

(73) Assignee: Valeo Schalter und Sensoren GmbH, Bietigheim-Bissingen (DE)

(21) Appl. No.: 18/278,116

(22) PCT Filed: Feb. 14, 2022
(86) PCT No.: PCT/EP2022/053454

§ 371 Date: Aug. 21, 2023

(30) Foreign Application Priority Data
Feb. 22, 2021 (DE) 102021104086.8

(51) Int. Cl. G01S 7/497; G01S 7/484

(52) U.S. Cl. CPC G01S 7/497; G01S 7/484

(57) ABSTRACT

A safety device for at least one light source for preventing exceeding specified light energy limits in the emission of light using the at least one light source is disclosed. The device includes at least one electrical component for influencing an electrical energy supply of at least one light source, and at least one electrical capacitive component, which is connected to a light source current path of the at least one light source. The device also has at least one state of charge comparison means, which is connected to at least one capacitive component, using which a state of charge variable characterizing a state of charge of the capacitive component is compared to a specified limiting state of charge variable and at least one alarm status for influencing the electrical energy supply of the at least one light source is set depending on the result of the comparison.

### TECHNICAL FIELD

The invention relates to a safety device for at least one light source,

for preventing exceeding specified light energy limits when emitting light using the at least one light source, which
includes at least one electrical component for influencing an electrical energy supply of at least one light source.

Furthermore, the invention relates to an emitting device for light, having at least one light source and having at least one safety device for preventing exceeding predetermined light energy limits when emitting light using the at least one light source,

wherein the at least one safety device includes at least one electrical component for influencing an electrical energy supply of at least one light source.

The invention furthermore relates to a detection apparatus for monitoring at least one monitoring region for objects by means of light signals,

having at least one emitting device having at least one light source for generating light signals,
having at least one receiving device for receiving light signals reflected in the at least one monitoring region,
wherein the at least one emitting device includes at least one safety device for preventing exceeding specified light energy limits when emitting light signals using the at least one light source,
wherein the at least one safety device includes at least one electrical component for influencing an electrical energy supply of at least one light source.

In addition, the invention relates to a vehicle having at least one detection apparatus for monitoring at least one monitoring region for objects by means of light signals, wherein the at least one detection apparatus includes

at least one emitting device having at least one light source for generating light signals, at least one receiving device for receiving light signals reflected in the at least one monitoring region,
wherein the at least one emitting device includes at least one safety device for preventing exceeding specified light energy limits when emitting light signals using the at least one light source,
wherein the at least one safety device includes at least one electrical component for influencing an electrical energy supply of at least one light source.

In addition, the invention relates to a method for operating at least one light source, in which

light signals are generated using the at least one light source and
using at least one safety device, if a specified light energy limit is exceeded in the emission of the light signals using the at least one light source, an electrical supply energy for supplying at least one light source is reduced.

### PRIOR ART

A laser driver having safety monitoring is known from EP 2 568 547 B1, in which the power emitted by the laser diode is monitored by a safety controller with the aid of a monitor diode. If the limits defined in the regulations are exceeded, continued energy supply of the laser diode is prevented, for example by opening a switch.

The invention is based on the object of designing a safety device, an emitting device, a detection apparatus, a vehicle and a method of the type mentioned at the outset in which it is possible to prevent a specified light energy limit from being exceeded in the emission of light using the at least one light source using simpler and/or more space-saving means.

### DISCLOSURE OF THE INVENTION

This object is achieved according to the invention in the safety device in that the safety device includes

at least one electrical capacitive component which is connected to a light source current path of the at least one light source,
at least one state of charge comparison means, which is directly or indirectly connected to at least one capacitive component, using which a state of charge variable characterizing a state of charge of the at least one capacitive component can be compared to a specified limiting state of charge variable and at least one alarm status for influencing the electrical energy supply of the at least one light source can be set depending on the result of the comparison.

According to the invention, at least one electrical capacitive component is provided, which is connected to the light source current path. The at least one electrical capacitive component can advantageously be connected using one terminal to the light source current path. The at least one electrical capacitive component can be connected to another potential, in particular to ground, using the other terminal.

The light source current path is formed by electrical lines and components arranged therein, in particular energy supply devices, consumers such as light sources, or other components. The light source current path can in particular be temporarily closed or interrupted in particular by corresponding electrical components, in particular switching components or the like. Electrical current can flow in the closed light source current path. No electrical current can flow in the interrupted light source current path.

As long as the light source current path is closed, the at least one light source emits light. The emitted light energy correlates with the duration for which the light source current path is closed and with the emitting power of the light source.

Due to the connection of the at least one capacitive component to the light source current path, as soon as the light source current path is closed, a charge exchange can take place between the at least one capacitive component and the light source current path. A state of charge of the at least one capacitive component can thus change as long as the light source current path is closed. The change of the state of charge and of the state of charge variable of the at least one capacitive component correlates with the duration for which the light source current path is open. The change of the state of charge and of the state of charge variable of the at least one capacitive component therefore correlates with the light energy which the at least one light source emits.

The state of charge of an electrical capacitive component is the state with respect to the amount of the electrical charge acquired using the capacitive component. The state of charge variable is a measure of the charge of the capacitive component. In this case, according to the invention the limiting state of charge variable can be reached during a discharge process, in which the capacitive component is discharged, or a charging process, in which the capacitive component is charged.

At least one limiting state of charge variable can advantageously characterize a specified light energy limit. The invention prevents the light energy limit from being exceeded. The emitted light energy can be the product of the light power of the at least one light source and the duration for which the at least one light source emits light. To prevent a light energy limit from being exceeded, the duration for which the at least one light source emits light can advantageously be limited to a limiting duration.

At least one limiting state of charge variable can advantageously be specified by corresponding selection of the components, in particular capacitances of capacitors, resistance values of electrical resistors or the like, and/or corresponding selection of operating voltages, in particular of charging voltages and/or discharging voltages. At least one limiting state of charge variable, in particular components and/or operating voltages used, can advantageously be specified in the course of a calibration.

The at least one limiting state of charge variable can advantageously characterize the limiting duration for which the at least one light source is permitted to emit light. Due to the connection of the at least one electrical capacitive component to the at least one light source current path, a charge cycle and/or a discharge cycle of the at least one electrical capacitive component correlates with the duration for which the at least one light source emits light. If the limiting duration is exceeded during a charge cycle or a discharge cycle of the at least one electrical capacitive component, the electrical capacitive component thus reaches the specified limiting state of charge variable. At least one alarm status is thereupon set.

In particular to prevent health damage and/or damage to the detection apparatus or surrounding objects, it can be necessary to prevent the emitted light energy from exceeding a specified light energy limit. In particular in the event of malfunctions of the controller of the at least one light source, it can be necessary to reduce the emitted light energy. The reduction of the emitted light energy can be achieved by reducing the power of the at least one light source, in particular by switching it off. This is achieved by corresponding influencing of the electrical energy supply of at least one light source, in particular switching off the energy supply.

The state of charge, in particular the state of charge variable, of the at least one capacitive component is compared by means of a state of charge comparison means to a specified limiting state of charge, in particular a limiting state of charge variable. The limiting state of charge, in particular the limiting state of charge variable, is specified so that it correlates with the specified light energy limit of the at least one light source. If the limiting state of charge, in particular the limiting state of charge variable, is reached, in particular if the limiting state of charge, in particular the limiting state of charge variable, is fallen below, or if the limiting state of charge, in particular the limiting state of charge variable, is exceeded, at least one corresponding alarm status can be set using the at least one state of charge comparison means.

It is possible to characterize using the at least one alarm status whether a state exists in which the energy supply of the at least one light source is to be reduced, in particular stopped. Upon the corresponding alarm status, the energy supply of the at least one light source can be influenced correspondingly, in particular the supply energy can be reduced or switched off.

The at least one alarm status can advantageously include two states, in particular a function state and an error state. In correct operation of the at least one light source, the at least one alarm status can have the function state. As soon as the reaching of the specified light energy limit is detected with the aid of the safety device, the at least one alarm status can be set to the error state.

The state of charge of at least one capacitive component can be characterized by an electrical voltage which is applied at the at least one capacitive component. The electrical voltage which is applied at the at least one capacitive component can be used as the state of charge variable which characterizes the state of charge. Electrical voltages can be ascertained using corresponding taps with little technical expenditure. Furthermore, electrical voltages, in particular the capacitor voltage and a limiting voltage, can be compared in a technically simple manner with the aid of electrical comparators.

The at least one light source can advantageously be a light source operable in a pulsed manner. In this way, light pulses can be emitted using the at least one light source.

The at least one light source and the safety device can advantageously be part of a detection apparatus for monitoring at least one monitoring region with the aid of light signals.

Advantageously, the detection apparatus can operate according to a light time-of-flight method, in particular a light pulse time-of-flight method. Optical detection apparatuses operating according to the light pulse time-of-flight method can be embodied and referred to as time-of-flight systems (TOF), light detection and ranging systems (LiDAR), laser detection and ranging systems (LaDAR), or the like. The at least one detection apparatus here can operate according to a direct light time-of-flight method or an indirect light time-of-flight method.

Advantageously, the detection apparatus can be embodied as a scanning system. In this context, a monitoring region can be sampled, that is to say scanned, using light signals. The detection apparatus can alternatively be embodied as a so-called flash system, in particular as flash LiDAR. In a flash system, corresponding light signals can simultaneously irradiate a relatively large part of the monitoring region or the entire monitoring region.

The at least one light source can advantageously be embodied as a laser, in particular as a diode laser. The laser can be used in particular to emit pulsed light signals. The laser can be used to emit light signals in wavelength ranges that are visible or not visible to the human eye.

The invention can advantageously be used in vehicles, in particular motor vehicles. The invention can advantageously be used in land vehicles, in particular passenger vehicles, trucks, buses, motorcycles or the like, aircraft, in particular drones, and/or watercraft. The invention can also be used in vehicles that may be operated autonomously or at least semiautonomously. However, the invention is not restricted to vehicles. It can also be used in a stationary scenario, in robotics and/or in machines, in particular construction or transport machinery, such as cranes, excavators or the like.

The detection apparatus can advantageously be connected to or can be part of at least one electronic control device of a vehicle or of a machine, in particular a driver assistance system and/or a chassis control system and/or a driver information device and/or a parking assistance system and/or a gesture recognition system or the like. In this way, at least some of the functions of the vehicle or of the machine can be operated autonomously or semiautonomously.

The detection apparatus can be used to detect stationary or moving objects, in particular vehicles, persons, gestures, movements, animals, plants, obstacles, roadway irregularities, in particular potholes or rocks, roadway boundaries, traffic signs, free spaces, in particular parking spaces, precipitation or the like.

In one advantageous embodiment,

at least one electrical capacitive component can include or consist of at least one electrical capacitor
and/or
at least one state of charge comparison means can include or consist of at least one comparator
and/or
at least one state of charge comparison means can be directly or indirectly connected to at least one switching component for switching at least one electrical path. In this way, the safety device can be implemented using simple and space-saving components.

At least one electrical capacitive component can advantageously include or consist of at least one electrical capacitor. Electrical capacitors can be implemented in a simple and space-saving manner. Electrical capacitors can store electric charges. A state of charge of an electrical capacitor can be characterized by a capacitor voltage. The capacitor voltage is used here as a state of charge variable of the capacitor.

Alternatively or additionally, the safety device can advantageously include at least one state of charge detection means. A state of charge variable of at least one electrical capacitive component can be ascertained using at least one state of charge detection means.

The at least one state of charge detection means can advantageously be directly or indirectly connected to the at least one capacitive component. In this way, the state of charge variable can be ascertained directly at the at least one capacitive component.

At least one state of charge detection means can advantageously include an electrical voltage detection means. In this way, an electrical voltage can be ascertained at the at least one electrical capacitive component. The electrical voltage can thus be ascertained as a state of charge variable of the electrical capacitive component.

The at least one state of charge detection means can advantageously be connected to the terminal of the at least one electrical capacitive component, using which the at least one electrical capacitive component is connected to the light source current path. In this way, the electrical voltage at the at least one electrical capacitive component can be ascertained in relation to ground.

Alternatively or additionally, at least one state of charge comparison means can advantageously include at least one comparator. Electrical voltages applied at the at least one electrical capacitive component can be compared to corresponding limiting voltages using a comparator. The limiting voltages can be used here as the limiting state of charge variables. At least one state variable for the alarm status can be output directly at the output of the comparator. At least one state variable can be digital here, in particular a logical zero or logical one. In this way, the electrical energy supply can accordingly be switched between two states, in particular switched on or switched off.

At least one comparator can advantageously be embodied as an analog comparator. In this way, analog variables, in particular analog state of charge variables of the electrical capacitive component, can be compared to one another.

At least one state of charge comparison means can advantageously be implemented using at least one microcontroller, at least one field-effect transistor (FET), and/or at least one operational amplifier (OPA).

Alternatively or additionally, at least one state of charge comparison means can advantageously be directly or indirectly connected to at least one switching component for switching at least one electrical path. In this way, the electrical path can be controlled, in particular closed or interrupted.

At least one electrical path can advantageously be a current path, in particular the light source current path. In this way, the current supply can be interrupted or closed directly in the current path, in particular the light source current path for the at least one light source.

Alternatively or additionally, at least one electrical path can be a control path. A control means, in particular a transistor or the like, for switching the light source current path can be controlled via the control path, in particular by means of a control voltage.

In a further advantageous embodiment, at least one electrical capacitive component can be arranged in at least one current path. The state of charge of at least one electrical capacitive component can be changed via the current path in particular independently of the operating state of the at least one light source.

At least one current path can advantageously be a charging current path. The at least one electrical capacitive component can be charged via the charging current path in particular independently of the operating state of the at least one light source.

Alternatively or additionally, at least one current path can be a discharging current path. The at least one electrical capacitive component can be discharged via a discharging current path in particular independently of the operating state of the at least one light source.

At least one electrical capacitive component can advantageously be electrically conductively connected to the light source current path of the at least one light source. In this way, the electrical capacitive component can be discharged or charged directly via the light source current path. In this case, the electrical capacitive component can additionally be arranged in a charging current path or discharging current path, in which it can be charged or discharged in operating phases in which the light source current path is interrupted.

Alternatively or additionally, at least one electrical capacitive component can advantageously be connected with respect to control by means of control means, in particular transistors or the like, to the light source current path of the at least one light source. The control means can release or interrupt a corresponding current path, in which the at least one electrical capacitive component is located, depending on whether the light source current path is open or interrupted. The current path having the electrical capacitive component here can be a discharging current path or a charging current path or a switchable current path.

The at least one electrical capacitive component can advantageously be charged in operating phases in which the light source current path is interrupted and the at least one light source does not emit light. As soon as the at least one light source current path is closed and at least one light source emits light, the electrical capacitive component can simultaneously be discharged via the light source current path.

If the at least one light source current path is alternately closed and interrupted, so that the at least one light source emits light pulses, the at least one electrical capacitive component can accordingly be alternately charged or discharged. The at least one electrical capacitive component, for the duration for which the light source current path is closed, can advantageously be discharged via this path. The at least one capacitive component can be charged via the at least one charging current path for the duration for which the light source current path is interrupted.

The at least one charging current path can advantageously include at least one charging current supply device. In this way, the at least one electrical capacitive component can be charged separately from a corresponding light source current supply device.

In a further advantageous embodiment, at least one electrical resistor can be arranged in the at least one current path. A charging current or discharging current and thus a charging time or discharging time can be specified by corresponding selection of the electrical resistor in combination with the capacitance of the at least one electrical capacitive component. The at least one electrical charging resistor and the at least one electrical capacitive component can thus implement a timing element.

In a further advantageous embodiment, between the at least one electrical capacitive component and the light source current path,

at least one electrical resistor
and/or
at least one current direction-dependent electrical blocking component can be arranged. With the aid of at least one electrical resistor, in particular a discharge resistor, with closed light source current path, an electrical current can be specified between the at least one electrical capacitive component and the light source current path, in particular a discharging current of the electrical capacitive component. The at least one electrical resistor and the at least one electrical capacitive component act as a timing element.

A discharging time can be specified by corresponding selection of the combination of the at least one electrical resistor, in particular the at least one electrical discharge resistor, and the at least one electrical capacitive component.

The safety device can be preset to the required light energy limit by appropriate combination of at least one electrical capacitive component, the electrical discharge resistor and/or possibly an electrical charge resistor.

Alternatively or additionally, at least one current direction-dependent electrical blocking component can be arranged between the at least one electrical capacitive component and the light source current path. In this way, the current direction can be specified by the electrical capacitive component in phases in which the light source current path is closed.

At least one current direction-dependent electrical blocking component can advantageously be designed so that the at least one electrical capacitive component can be charged via a charging current path when the light source current path is interrupted and can be discharged via the light source current path when the light source current path is closed. In this way, the at least one electrical capacitive component can be alternately charged and discharged in the cycle of the emission of light. In correct operation, the charging cycles and discharging cycles can equalize, so that the state of charge of the at least one electrical capacitive component remains above a limiting state of charge. As soon as the state of charge variable falls below the limiting state of charge variable, at least one alarm status can accordingly be set using the at least one state of charge comparison means.

In a further advantageous embodiment, at least one controllable electrical light source switching component can be arranged in the light source current path. The light source current path can be alternately closed or interrupted using the electrical light source switching component. An electrical current through the light source current path and thus the light emission using the at least one light source can thus be influenced.

At least one controllable electrical light source switching component can advantageously include or consist of at least one transistor, in particular a pnp transistor, an npn transistor, a field-effect transistor (FET) and/or a metal oxide semiconductor field-effect transistor (MOSFET), or another controllable switching component in particular with a high active reset output or a low active reset output.

In a further advantageous embodiment, the at least one light source switching component can be connected in a controllable manner to at least one signal generating means. A switching state of the electrical light source switching component can be set using the at least one signal generating means.

Switching signals, in particular switching pulses, for controlling the at least one controllable electrical light source switching component can be generated using the at least one signal generating means. The light source current path can thus be closed and interrupted, in particular alternately, in accordance with the switching signals.

At least one signal generating means can advantageously include or consist of a pulse generator. In this way, a control input of at least one controllable electrical light source switching component can be activated using control pulses. In this way, the light source current path is closed and interrupted in accordance with the control pulses, so that corresponding light pulses can be emitted using the at least one light source.

The at least one signal generating means can be part of a light generating device with the at least one light source. The light generating device can be part of a detection apparatus with the safety device.

In a further advantageous embodiment, at least one state of charge comparison means can be directly or indirectly connected

to at least one switching component of at least one light source current supply device for the at least one light source
and/or
to at least one switching component in a supply current path of at least one light source current supply device for the at least one light source
and/or
to at least one signal generating means in a control path of at least one light source switching component
and/or
to at least one switching component in the light source current path. In this way, the electrical energy supply of the at least one light source can be controlled, in particular reduced or switched off, via the state of charge comparison means.

At least one state of charge comparison means can advantageously be connected to at least one switching component of at least one light source current supply device of the at least one light source. In this way, the light source current supply device can be controlled, in particular switched off, accordingly using a switching component contained therein.

Alternatively or additionally, at least one state of charge comparison means can advantageously be connected to at least one switching component in the supply current path of the at least one light source current supply device of the at least one light source. In this way, the current supply of the at least one light source current supply device can be controlled, in particular switched off, accordingly.

Alternatively or additionally, at least one state of charge comparison means can advantageously be connected to at least one control input of at least one light source switching component in the light source current path. In this way, a current through the light source current path can be controlled, in particular switched off, via the at least one light source switching component.

Alternatively or additionally, at least one state of charge comparison means can advantageously be connected to at least one signal generating means in a control path of at least one light source switching component. In this way, if an error is detected using the safety device, the light source switching component can be activated by means of the at least one signal generating means to close.

At least one output of the at least one state of charge comparison means can advantageously be connected via at least one further component, in particular at least one further control and/or switching means, indirectly to at least one switching component and/or at least one control input and/or at least one signal generating means. Additional functions can be implemented in this way.

Alternatively or additionally, at least one output of the at least one state of charge comparison means can advantageously be directly connected to at least one switching component and/or at least one control input and/or at least one signal generating means. In this way, the number of required components can be reduced.

Alternatively or additionally, at least one state of charge comparison means can be directly or indirectly connected to at least one switching component in the light source current path. In this way, the light source current path can be directly interrupted.

Furthermore, the object is achieved according to the invention in the emitting device in that the safety device includes

at least one electrical capacitive component which is connected to a light source current path of the at least one light source,
at least one state of charge comparison means, which is directly or indirectly connected to at least one capacitive component, using which a state of charge variable characterizing a state of charge of the at least one capacitive component can be compared to a specified limiting state of charge variable and at least one alarm status for influencing the electrical energy supply of the at least one light source can be set depending on the result of the comparison.

In this way, the safety, in particular the ocular safety and/or the safety of objects illuminated using the at least one emitting device, can be improved during operation of the emitting device. The emitting device can thus also be operated in situations, for example in road traffic, in which persons can be subjected to the light emitted using the emitting device.

Furthermore, the object is achieved according to the invention in the detection apparatus in that the safety device includes

at least one electrical capacitive component which is connected to a light source current path of the at least one light source,
at least one state of charge comparison means, which is directly or indirectly connected to at least one capacitive component, using which a state of charge variable characterizing a state of charge of the at least one capacitive component can be compared to a specified limiting state of charge variable and at least one alarm status for influencing the electrical energy supply of the at least one light source can be set depending on the result of the comparison.

In this way, safety, in particular the ocular safety and/or the safety of objects illuminated using the at least one emitting device, can be improved during operation of the detection apparatus. The detection apparatus can thus also be operated in situations, for example in road traffic, in which persons can be subjected to the light emitted using the emitting device.

In addition, the object is achieved according to the invention in the vehicle in that the safety device includes

at least one electrical capacitive component which is connected to a light source current path of the at least one light source,
at least one state of charge comparison means, which is directly or indirectly connected to at least one capacitive component, using which a state of charge variable characterizing a state of charge of the at least one capacitive component can be compared to a specified limiting state of charge variable and at least one alarm status for influencing the electrical energy supply of the at least one light source can be set depending on the result of the comparison.

The vehicle can advantageously include at least one driver assistance system. In this way, the vehicle can be operated autonomously or at least semiautonomously.

The at least one detection apparatus can advantageously be connected to a driver's seat identification system of the vehicle. In this way, the vehicle can be operated autonomously or at least semiautonomously on the basis of information ascertained using the at least one detection apparatus, in particular object information, from at least one monitoring region.

According to the invention, the object is furthermore achieved in the method in that a light source current path, in which the at least one light source is located, is at least temporarily closed,

a state of charge variable characterizing a state of charge of at least one electrical capacitive component, which is connected to the light source current path, is compared to a specified limiting state of charge variable,
at least one alarm status is set depending on the result of the comparison
and the energy supply of the at least one light source is controlled on the basis of the at least one alarm status.

According to the invention, the state of charge of at least one capacitive component is changed via the closed light source current path. The at least one capacitive component can advantageously be discharged via the closed light source current path in particular in relation to another potential, in particular in relation to ground.

If the state of charge of the at least one capacitive component, which is characterized by the state of charge variable, reaches the specified limiting state of charge variable, the at least one alarm status is set to an error state. Upon the error state, the energy supply of the at least one light source is controlled accordingly, in particular switched off.

In one advantageous embodiment of the method, a state of charge of at least one electrical capacitive component in a current path can be changed. In this way, the at least one capacitive component can be charged or discharged independently of whether the light source current path is closed or interrupted.

At least one current path can advantageously be a charging current path, in which the at least one electrical capacitive component can be charged. Alternatively or additionally, at least one current path can be a discharging current path, in which the at least one electrical capacitive component can be discharged. The current path can also be switchable. The at least one electrical capacitive component can thus be charged or discharged via the current path depending on the setting.

In a further advantageous embodiment of the method, the light source current path can be alternately closed and interrupted. In this way, the at least one light source can be alternately activated. Light pulses can thus be emitted using the at least one light source. In addition, the at least one capacitive component can be alternately discharged and charged via the alternately closed and interrupted light source current path in connection with the charging current path. In this way, in correct operation, a state of charge of the at least one capacitive component can be kept above or below a limiting state of charge.

Moreover, the features and advantages indicated in conjunction with the safety device according to the invention, the emitting device according to the invention, the detection apparatus according to the invention, the vehicle according to the invention and the method according to the invention and the respective advantageous embodiments thereof apply in a mutually corresponding manner and vice versa. The individual features and advantages can of course be combined with one another, wherein further advantageous effects that go beyond the sum of the individual effects may result.

### BRIEF DESCRIPTION OF THE DRAWINGS

Further advantages, features and details of the invention will become apparent from the following description, in which exemplary embodiments of the invention are explained in greater detail with reference to the drawing. A person skilled in the art will expediently also consider individually the features that have been disclosed in combination in the drawing, the description and the claims and will combine them to form meaningful further combinations. Schematically, in the figures,

FIG. 1 shows a front view of a vehicle having a driver assistance system and a LiDAR system for monitoring a monitoring region in the travel direction in front of the vehicle;

FIG. 2 shows a functional illustration of the vehicle having the driver assistance system and the LiDAR system from FIG. 1;

FIG. 3 shows a functional illustration of an emitting device of the LiDAR system from FIGS. 1 and 2 according to a first exemplary embodiment;

FIG. 4 shows a comparison of the time curve of an electrical capacitor voltage of a capacitor and an alarm status of a safety device of the emitting device from FIG. 3;

FIG. 5 shows a functional illustration of an emitting device of the LiDAR system from FIGS. 1 and 2 according to a second exemplary embodiment;

FIG. 6 shows a comparison of the time curve of an electrical capacitor voltage of a capacitor and an alarm status of a safety device of the emitting device from FIG. 5.

In the figures, identical components are provided with identical reference signs.

### EMBODIMENT(S) OF THE INVENTION

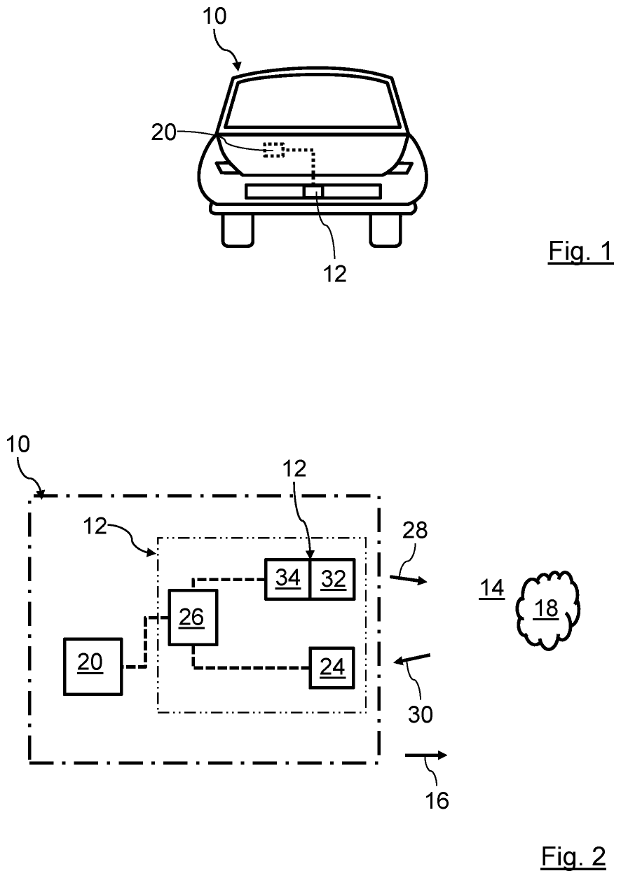

FIG. 1 shows the front view of a vehicle 10 in the form of a passenger vehicle. FIG. 2 shows a functional illustration of the vehicle 10.

The vehicle 10 has an optical detection apparatus for example in the form of a LiDAR system 12. The LiDAR system 12 is arranged by way of example in the front fender of the vehicle 10 and is directed into a monitoring region 14 in the travel direction 16 in front of the vehicle 10. The LiDAR system 12 can be used to monitor the monitoring region 14 for objects 18. The LiDAR system 12 can also be arranged and oriented differently at another location on the vehicle 10.

The LiDAR system 12 can detect stationary or moving objects 18, for particular vehicles, persons, gestures, movements, animals, plants, obstacles, roadway irregularities, in particular potholes or rocks, roadway boundaries, traffic signs, free spaces, in particular parking spaces, precipitation or the like.

Furthermore, the vehicle 10 has a driver assistance system 20. The vehicle 10 can be operated autonomously or semiautonomously using the driver assistance system 20. The driver assistance system 20 is functionally connected to the LiDAR system 12. Object information, for example distances, directions and/or velocities of objects 18 relative to the vehicle 10, which are detected using the LiDAR system 12, can thus be transmitted to the driver assistance system 20. The object information can be used to control the operation of the vehicle 10 by the driver assistance system 20.

The LiDAR system 12 comprises, by way of example, an emitting device 22, a receiving device 24 and a control and evaluation device 26.

Scanning light pulses 28 can be emitted using the emitting device 22. The scanning light pulses 28 can optionally be guided using a deflection device (of no further interest here) into the monitoring region 14.

Echo light pulses 30, which originate from the scanning light pulses 28 that are reflected at an object 18 in the monitoring region 14, can be received and converted into electrical signals using the receiving device 24.

The electrical signals that are generated using the receiving device 24 can be processed using the control and evaluation device 26 and the corresponding object information can be obtained therefrom. The LiDAR system 12 can operate, for example, according to a so-called time-of-flight method (TOF). The information obtained using the LiDAR system 12 can be transmitted by the control and evaluation device 26 to the driver assistance system 12 and be processed thereby. Furthermore, the functions of the LiDAR system 12 can be controlled using the control and evaluation device 26.

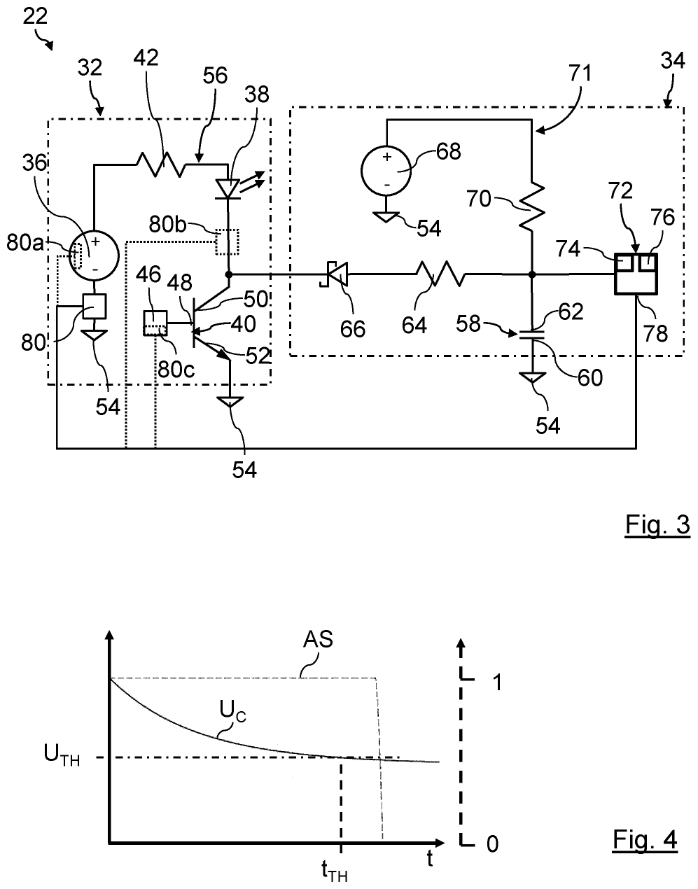

The emitting device 22 comprises a light generating device 32 and a safety device 34. A circuit diagram of an emitting device 22 according to a first exemplary embodiment is shown in FIG. 3.

The scanning light pulses 28 can be generated using the light generating device 32. The ocular safety of the emitting device 22 can be increased using the safety device 34. Using the safety device 34, it is possible to prevent, for example in case of a malfunction in the LiDAR system 12, the light energy emitted by the scanning light pulses 28 from becoming so high that it can result in damage to the eye.

The light generating device 32 comprises an electrical light source supply device 36, a light source in the form of a laser diode 38 and a light switching means in the form of a transistor 40.

The light source supply device 36 can be, for example, a current supply device in the form of a power supply unit or the like, using which the laser diode 38 can be supplied with electric current.

In addition, the light generating device 32 comprises an electrical resistor 42. The electrical resistor 42 is arranged between a terminal, for example a positive pole, of the light source supply device 36 and the laser diode 38. The negative pole of the light source supply device 36 is connected to the ground 54.

Furthermore, the light generating device 32 comprises an electrical signal generating means 46, using which electrical control signals for generating the scanning light pulses 28 can be generated. The signal generating means 46 is connected to a control input, for example the base 48 of the transistor 40.

The transistor 40 is designed by way of example as an npn transistor. In another exemplary embodiment (not shown) of a light source supply device and another circuit, a pnp transistor, an FET, a MOSFET or the like can instead be used.

One power terminal of the transistor 40, for example the collector 50, is connected to the free terminal of the laser diode 38. The other power terminal of the transistor 40, for example the emitter 52, is connected to the ground 54.

Overall, the light source supply device 36, the electrical resistor 42, the laser diode 38, the transistor 40, and corresponding connecting lines form a light source current path 56. The light source current path 56 can be closed or interrupted, for example, by switching the transistor 40 or in another manner.

During operation of the emitting device 22, control signals for example in the form of voltage pulses are generated using the signal generating means 46, which are applied at the base 48 of the transistor 40. The transistor 40 is accordingly switched to open in a pulsed manner, so that the light source current path 56 is closed and an electric current flows through the laser diode 38. Light energy is emitted by the laser diode 38 for the duration of the opening of the transistor 40.

To ensure the ocular safety, the emitted light energy cannot exceed a specified light energy limit. To prevent for example the light energy limit from being exceeded in the case of a malfunction of the emitting device 22, the light source current conducting path 56 is monitored and if necessary interrupted using the safety device 34.

The safety device 34 includes an electrical capacitive component in the form of a capacitor 58. The capacitor 58 is connected using one capacitor terminal 60 to the ground 54. The other capacitor terminal 62 is connected via an electrical resistor, for example a discharge resistor 64, and a current direction-dependent electrical blocking element, for example a diode 66, between the laser diode 38 and the collector 50 of the transistor 40 to the light source current path 56. For example, the diode 66 can be a rapidly switching diode, for example a Schottky diode. Schottky diodes can switch reliably between blocking and transmission even with rapid current direction changes.

The diode 66 is arranged with respect to its blocking direction so that the capacitor 58 can be discharged but not charged via the light source current path 56. For example, the cathode of the diode 66 is connected to the light source current path 56 and the anode is connected to the discharge resistor 64.

The capacitor 58 and the discharge resistor 64 form a timing element for the discharge of the capacitor 58.

Furthermore, the safety device 34 has an electrical charging supply device 68. The charging supply device can be, for example, a current supply device in the form of a power supply unit or the like, using which the capacitor 58 can be supplied with electrical charging current.

The charging supply device 68 is connected, for example, with its positive pole via an electrical resistor, for example a charge resistor 70, to the capacitor terminal 62 of the capacitor 58. The negative pole of the charging supply device 68 is connected to the ground 54. The charging supply device 68, the charge resistor 70 and the capacitor 58 form a charging current path 71.

In charging of the capacitor 58, the charge resistor 70 and the capacitor 58 form a timing element for the charging of the capacitor 58.

Furthermore, the safety device 34 comprises a checking device 72.

The checking device 72 includes a state of charge detection means in the form of a voltage detection means 74. The voltage detection means 74 is connected to the capacitor terminal 62 of the capacitor 58. The capacitor voltage U_{C} applied at the capacitor 58 can be detected using the voltage detection means 74. The capacitor voltage U_{C} applied at the capacitor 58 characterizes the state of charge of the capacitor 58 and is used as a state of charge variable.

Furthermore, the checking device 72 includes a state of charge comparison means, for example in the form of an analog electrical comparator 76. The state of charge comparison means can be implemented, for example, using a microcontroller, a field-effect transistor (FET) and/or an operational amplifier (OPA).

Using the comparator 76, the state of charge of the capacitor 58, namely the state of charge variable in the form of the capacitor voltage U_{C}, can be compared to a specified limiting state of charge, for example a limiting state of charge variable in the form of a limiting capacitor voltage U_{TH}. If the capacitor voltage U_{C} reaches the specified limiting capacitor voltage U_{TH}, an alarm status AS of the safety device 34 can be set to an error state using the comparator 76. The specified limiting capacitor voltage U_{TH} is reached when the capacitor 58 is discharged for a limiting duration t_{TH}. The limiting duration is the maximum duration for which the laser diode 38 can emit light.

For example, a logical one or a corresponding potential can be output as the release state of the alarm status AS at the output of the comparator 76, as long as the capacitor voltage U_{C} is above the limiting capacitor voltage U_{TH}. If the capacitor voltage U_{C} falls below the limiting capacitor voltage U_{TH}, a logical zero or a corresponding potential can be output as the error state of the alarm status AS at the output of the comparator 76. Alternatively, the comparator 76 can be designed so that a logical zero is output as the release state and a logical one as the error state of the alarm status AS.

The alarm status AS at the output of the comparator 76 can be output via a signal output 78 of the checking device 72. The alarm status AS can be transmitted as a control signal to a safety switching component 80. The energy supply of the laser diode 38 can accordingly be limited, for example interrupted, using the safety switching component 80.

For example, the safety switching component 80 can be arranged in the current supply of the light source supply device 36 between the negative pole and the ground 54. The current supply of the light source supply device 36 can thus be interrupted using the safety switching component 80.

Additionally or alternatively, safety switching components can be arranged at other points of the light generating device 32. Three safety switching components 80a, 80b and 80c are indicated by dashed lines by way of example in FIG. 3. The safety switching component 80a can be integrated, for example, in the light source supply device 36. Alternatively or additionally, a safety switching component 80b can be arranged in the light source current path 56 between the laser diode 38 and the transistor 40. The light source current path 56 can thus be interrupted there. Alternatively or additionally, a safety switching component 80c can be integrated in the signal generating means 46. In this way, the control signal of the signal generating means 46 can be influenced accordingly, so that the transistor 40 is blocked and the light source current path 56 is thus interrupted.

In operation of the LiDAR system 12, a pulsed control signal is generated using the signal generating means 46, using which the transistor 40 is accordingly switched to transmit or block in a pulsed manner. As a result, the light source current conducting path 56 is alternately closed and interrupted.

In phases in which the transistor 40 is switched to transmit and the light source current path 56 is closed, current flows through the laser diode 38, so that it emits scanning light pulses 28. In addition, in phases in which the transistor 40 is switched to transmit, the capacitor 58 is switched via the diode 66 of the safety device 34 in the opening direction, so that the capacitor 58 can discharge via the discharge resistor 64.

In contrast, during the blocking phase of the transistor 40, the light source current path 56 is interrupted, so that no current can flow through the laser diode 38. The laser diode 38 does not emit scanning light pulses 28 in this phase. In addition, the diode 66 blocks in this phase, so that the discharge of the capacitor 58 is interrupted.

In correct operation of the emitting device 22, the discharge of the capacitor 58 is equalized by the charging of the capacitor 58 using the charging supply device 68 via the charge resistor 70. In this way, the capacitor voltage U_{C} of the capacitor 58 always remains above the limiting voltage in correct operation. In correct operation, the release state is applied at the signal output 78 of the checking device 72 as the alarm status AS, so that the safety switching component 80 having the checking device 72 remains released.

If, for example due to a malfunction in the controller of the transistor 40 or of the transistor 40 itself, the opening times of the transistor 40 lengthen so that the specified light energy limit can be exceeded in the emission of the scanning light pulses 28 using the laser diode 38, the discharge time of the capacitor 58 also increases accordingly. The discharge of the capacitor 58 can no longer be equalized using the charging supply device 68. The state of charge of the capacitor 58 and thus the capacitor voltage U_{C} decrease. If the capacitor voltage U_{C} sinks below the specified limiting capacitor voltage U_{TH}, the variable at the output of the comparator 76 thus changes in the error state of the alarm status AS.

The error state of the alarm status AS is output to the signal output 78. The safety switching component 80 is activated to close on the basis of the error state of the alarm status AS. The energy supply of the laser diode 38 is interrupted and the generation of scanning light pulses 28 is stopped. Overall, the ocular safety is thus reestablished.

In FIG. 4, the time curve of the capacitor voltage U_{C} and the alarm status AS is qualitatively compared by way of example. Upon falling below the limiting capacitor voltage U_{TH}, the alarm status AS switches from the release state 1 to the error state 0.

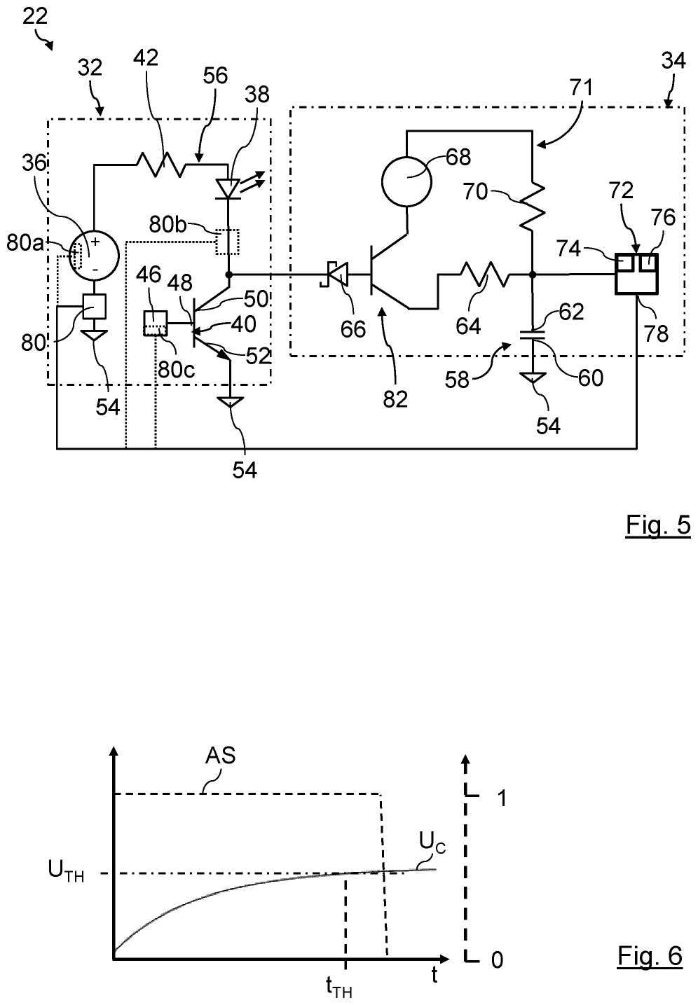

FIG. 5 shows a circuit diagram of an emitting device 22 according to a second exemplary embodiment. Those elements which are similar to those of the first exemplary embodiment from FIG. 3 are provided with the same reference signs. The second exemplary embodiment differs from the first exemplary embodiment in that the capacitor 58 is charged via a control means in the form of a transistor 82 during an operating phase in which the light source current path 56 is closed. The base of the transistor 82 is connected for this purpose via the diode 66 to the light source current path 56. One power terminal of the transistor 82 is connected to the resistor 64, which acts here as a charge resistor. The other power terminal of the transistor 82 is connected via a suitable supply device 68.

In an operating phase in which the light source current path 56 is closed, the capacitor 58 is charged via the charge resistor 64. The profile of a charging curve is shown by way of example in FIG. 6. In an operating phase in which the light source current path 56 is interrupted, thus no light is emitted by the laser diode 38, the capacitor 58 is discharged via the discharge resistor 70. The capacitor voltage U_{C} is compared here as in the first exemplary embodiment by means of the checking device 72 to the limiting capacitor voltage U_{TH}.

1. A safety device for at least one light source, for preventing exceeding specified light energy limits in the emission of light using the at least one light source, which includes at least one electrical component for influencing an electrical energy supply of at least one light source, the device comprising:
at least one electrical capacitive component connected to a light source current path of the at least one light source; and
at least one state of charge comparison means directly or indirectly connected to at least one capacitive component, using which a state of charge variable characterizing a state of charge of the at least one capacitive component is compared to a specified limiting state of charge variable and at least one alarm status for influencing the electrical energy supply of the at least one light source is set depending on the result of the comparison.

2. The safety device as claimed in claim 1, wherein at least one electrical capacitive component includes or consists of at least one electrical capacitor and/or at least one state of charge comparison means includes or consists of at least one comparator and/or at least one state of charge comparison means is directly or indirectly connected to at least one switching component for switching at least one electrical path.

3. The safety device as claimed in claim 1, wherein at least one electrical capacitive component is arranged in at least one charging current path or one discharging current path.

4. The safety device as claimed in claim 3, wherein at least one electrical resistor is arranged in the at least one current path.

5. The safety device as claimed in claim 1, wherein, between the at least one electrical capacitive component and the light source current path, at least one electrical resistor and/or at least one current direction-dependent electrical blocking component is arranged.

6. The safety device as claimed in claim 1, wherein at least one controllable electrical light source switching component is arranged in the light source current path.

7. The safety device as claimed in claim 6, wherein the at least one light source switching component is controllably connected to at least one signal generating means.

8. The safety device as claimed in claim 1, wherein at least one state of charge comparison means is directly or indirectly connected to at least one switching component of at least one light source current supply device for the at least one light source and/or to at least one switching component in a supply current path of at least one light source current supply device for the at least one light source and/or to at least one signal generating means in a control path of at least one light source switching component and/or to at least one switching component in the light source current path.

9. An emitting device for light, comprising:
at least one light source;
at least one safety device for preventing exceeding specified light energy limits in the emission of light using the at least one light source,
wherein the at least one safety device includes at least one electrical component for influencing an electrical energy supply of at least one light source,
wherein the safety device includes at least one electrical capacitive component, which is connected to a light source current path of the at least one light source; and
at least one state of charge comparison means, which is directly or indirectly connected to at least one capacitive component, using which a state of charge variable characterizing a state of charge of the at least one capacitive component is compared to a specified limiting state of charge variable and at least one alarm status for influencing the electrical energy supply of the at least one light source is set depending on the result of the comparison.

10. A detection apparatus for monitoring at least one monitoring region for objects by light signals, comprising:
at least one emitting device having at least one light source for generating light signals;
at least one receiving device for receiving light signals reflected in the at least one monitoring region,
wherein the at least one emitting device includes at least one safety device for preventing exceeding specified light energy limits in the emission of light signals using the at least one light source,
wherein the at least one safety device includes at least one electrical component for influencing an electrical energy supply of at least one light source,
wherein the safety device includes at least one electrical capacitive component, which is connected to a light source current path of the at least one light source; and
at least one state of charge comparison means, which is directly or indirectly connected to at least one capacitive component, using which a state of charge variable characterizing a state of charge of the at least one capacitive component is compared to a specified limiting state of charge variable and at least one alarm status for influencing the electrical energy supply of the at least one light source is set depending on the result of the comparison.

11. A vehicle comprising at least one detection apparatus for monitoring at least one monitoring region for objects by light signals, wherein the at least one detection apparatus includes
at least one emitting device having at least one light source for generating light signals,
at least one receiving device for receiving light signals reflected in the at least one monitoring region,
wherein the at least one emitting device includes at least one safety device for preventing exceeding specified light energy limits in the emission of light signals using the at least one light source,
wherein the at least one safety device includes at least one electrical component for influencing an electrical energy supply of at least one light source,
wherein the safety device includes at least one electrical capacitive component, which is connected to a light source current path of the at least one light source, and
at least one state of charge comparison means, which is directly or indirectly connected to at least one capacitive component, using which a state of charge variable characterizing a state of charge of the at least one capacitive component is compared to a specified limiting state of charge variable and at least one alarm status for influencing the electrical energy supply of the at least one light source is set depending on the result of the comparison.

12. A method for operating at least one light source, comprising:
generating light signals using the at least one light source and using at least one safety device;
if a specified light energy limit is exceeded in the emission of the light signals using the at least one light source, reducing an electrical supply energy for supplying at least one light source,
wherein a light source current path, in which the at least one light source is located, is at least temporarily closed,
comparing a state of charge variable characterizing a state of charge of at least one electrical capacitive component, which is connected to the light source current path, to a specified limiting state of charge variable,
at least one alarm status is set depending on the result of the comparison and the energy supply of the at least one light source is controlled on the basis of the at least one alarm status.

13. The method as claimed in claim 12, wherein a state of charge of at least one electrical capacitive component in a current path is changed.

14. The method as claimed in claim 12, wherein the light source current path is alternately closed and interrupted.
